(19) United States
(12) Patent Application Publication
(10) Pub. No.: US 2007/0127474 A1
(43) Pub. Date: Jun. 7, 2007

(54) Automatic mapping of an IPv6 packet in multi-topology routing

(75) Inventors: Sina Mirtorabi, Santa Clara, CA (US); Abhay Roy, Santa Clara, CA (US)

Correspondence Address: SIERRA PATENT GROUP, LTD., 1657 Hwy 395, Suite 202, Minden, NV, 89423, US

(73) Assignee: Cisco Technology, Inc.

(21) Appl. No.: 11/292,535

(22) Filed: Dec. 2, 2005

(51) Int. Cl. H04L 12/56; H04J 3/26

(52) U.S. Cl. 370/390; 370/432

(57) ABSTRACT

The present invention provides automatic classification of an IPv6 packet to a given topology. A topology identifier is carried as an embedded field in the interface ID portion of an IPv6 address. Automatic classification of an IPv6 packet for a given topology prevents manual configuration in intermediate nodes. Further, it remedies the value limit problem of differentiated services code points (DSCPs) and re-use of DSCP values within each topology.

### FIELD

The present invention relates broadly to packet-switched networks. Specifically, the present invention relates to automatically configuring a router to send a received packet along a communication path to a logical topology identified within the packet.

### BACKGROUND

Multi-topology Routing (MTR) involves mechanisms that build multiple independent logical topologies on top of a physical topology, and classify and forward packets belonging to different topologies. Two processes are key to MTR. The first is an extension to Routing Protocol used to build multiple independent topologies. The other key process is the marking and classification of the packet as belonging to a given topology.

Extension to routing protocols have already been defined in order to create multiple logical topologies. Marking the packet is required in order to be able to classify the packet as belonging to which topology so that the correct RIB could be used to forward the packet. There are not many choices in IP headers for marking a packet. Typically, a differentiated services code point (DSCP) is used in order to mark a packet. However, this approach suffers a significant shortcoming in that each node in the network has to consistently be configured in order to map the DSCP to the corresponding topology identified by multi-topology identifier (MT-ID). The problem with this approach is that not only does it require consistent mapping in all routers and is prone to misconfiguration, but DCSP values are limited and may be used for other purposes within a topology.

### SUMMARY

The present invention carries the topology that a packet belongs to as a MT-ID, as indicated in an embedded field within an IPv6 address. This allows the originator of the packet to set the MT-ID in the packet; all other routers automatically associate the packet to its corresponding topology, thereby reducing manual configuration and the possibility of any erroneous configuration. It is to be understood that routers used in embodiments of the present invention are multi-topology routing (MTR) aware, and IPv6 packets generated by an end host router are marked to indicate such a marking.

In one aspect, the present invention provides a method of routing packets that belong to a logical network topology associated with a physical topology, by generating a packet having an IPv6 format with a multi-topology identifier (MT-ID) uniquely identifying a logical topology that is carried as an embedded field in the Interface ID part of the IPv6 address. IPv6 unicast addresses include a 64-bit interface identifier field in modified EUI-64 format, based on the IEEE EUI-64 (referred to herein as EUI64) specification. The modified EUI-64 format inverts the sense of the ‘u/l’ bit from its specification in EUI64, i.e., ‘u/i’=0 indicates local use. The Intra-site Automatic Tunnel Addressing Protocol (ISATAP) already specifies an EUI64-format address construction for the Organizationally-Unique Identifier (OUI) assigned by the Internet Assigned Numbers Authority (IANA). This format is used to construct both native EUI64 addresses for general use and modified EUI-64 format interface identifiers for use in IPv6.

In another aspect, the present invention provides a method for routing packets that belong to a logical network topology, by receiving a packet having an IPv6 format with a MT-ID contained in its interface identifier field. Upon receipt by a router in accordance with the present invention, the MT-ID is read, and the router associates the received packet with the topology identified by the MT-ID by inspecting a local table that maps MT-IDs with logical topologies, and reading a routing table that determines where to send the received packet so that it reaches its logical topology.

Other features and advantages of the present invention will be realized upon reading the following detailed description, when considered in conjunction with the drawings, in which:

### BRIEF DESCRIPTION OF THE DRAWINGS

FIG. 1 illustrates a network of routers in accordance with the present invention;

FIG. 2 illustrates in block form major components of routers depicted in FIG. 1;

FIG. 3 illustrates in block form the organization of an IPv6 packet header with the MT-ID of the present invention included;

FIG. 4 illustrates the logical sequence of acts executed by an originating router; and

FIG. 5 illustrates the logical sequence of acts executed by a receiving router.

### DETAILED DESCRIPTION

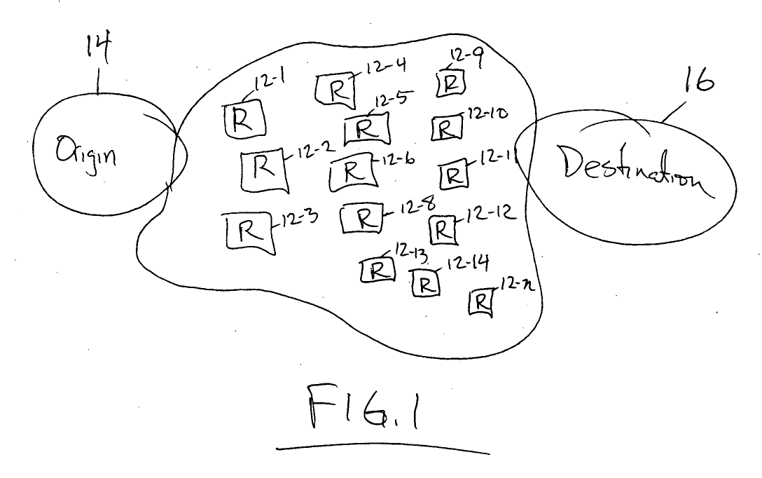

Direction attention to FIG. 1, there is shown network 10 of interconnected routers 12. While five routers are illustrated, it is to be understood that the number of routers in a network can be much greater, or even smaller, depending on the configuration of network 10. Routers 12 collectively function to communicate IPv6 packets across network 10 from an originating point 14 to a destination point 16. It is to be understood that originating point 14 and destination point 16 can be individual devices manipulated by a user, such as conventional computers, portable computers and other wireless communication devices such as cellular telephones. Within network 10, individual logical topologies 14 exist. Logical topologies 14 are subgroupings of the various routers 12.

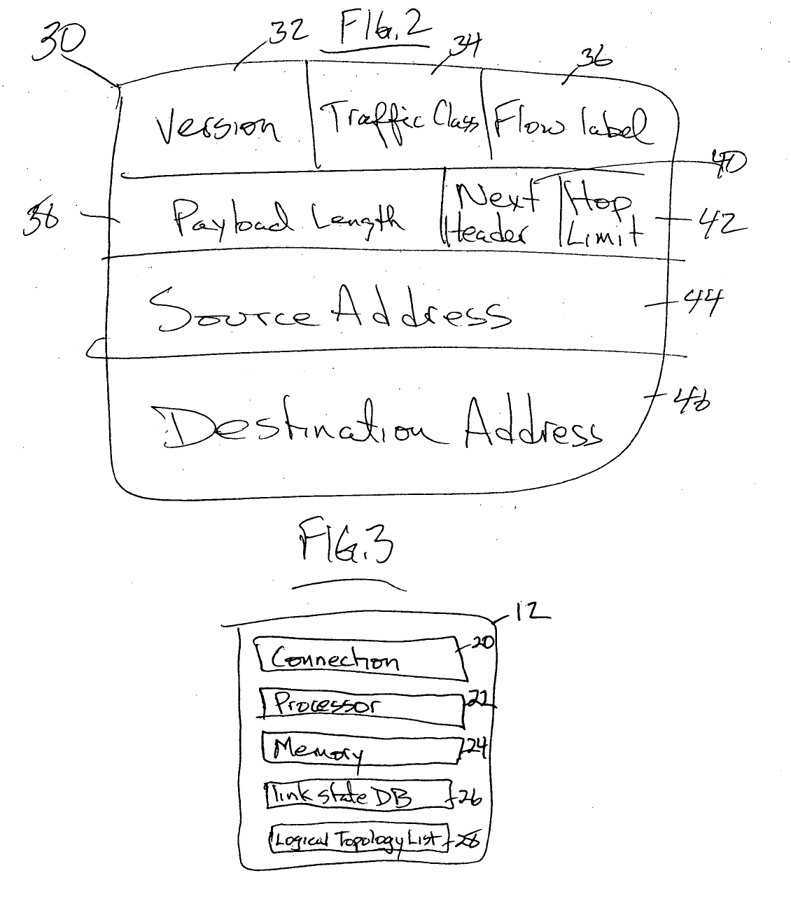

Directing attention to FIG. 2, functional elements of router 12 include communication connection 20, processor 22, memory 24, link state database 26, and logical topology list 28. Logical topology list 28 contains the identities of routers that belong to logical topologies as well as MT-IDs associated with the various logical topologies. Other components, commonly found in routers known to those skilled in the art, are included in router 12, but are not illustrated.

Routers 12 are configured to handle IPv6 packets modified in accordance with the present invention. Directing attention to FIG. 3, the general organization of fields in IPv6 packet header 30 is illustrated. Version 32 specifies the version of the IPv6 protocol being used. Traffic class 34 is an 8-bit field that specifies an Internet traffic priority delivery value. Flow label 36 is a 20 bit field that specifies special router handling from source to destination(s) for a sequence of packets. Payload length 38 is a 16 bit unsigned field that specifies the length of the data in the packet. When cleared to zero, the option is a hop-by-hop Jumbo payload. Next header 40 is an 8-bit field that specifies the next encapsulated protocol. Hop limit 42 is an 8-bit unsigned field that specifies a value that is initially set to the maximum number of hops the packet can make between routers before it is discarded. For each router that forwards the packet, the hop limit is decremented by 1. When the hop limit field reaches zero, the packet is discarded. This replaces the TTL field in the IPv4 header that was originally intended to be used as a time based hop limit. Source address 44 is a 16-byte field that specifies the IPv6 address of the sending node. Likewise, destination address 46 is 16-byte field that specifies the IPv6 address of the destination node.

The Organizational Unique Identifier (OUI) is found in the first 24 bits of a MAC address for a network-connected device, which indicate the specific vendor for that device. The IEEE assigns OUIs to vendors. (The last 24 bits of the MAC address are the device's unique serial number, assigned to the device by the manufacturer.) The OUI sometimes is referred to as the Vendor ID.

Below is an example of an Interface ID that uses the IANA OUI Assignment:

|0 2|2 3|3 3|4 6|
|0 3|4 1|2 9|0 3|
+----------------------------+--------+--------+-------------+
|OUI(“00-00-5E” + u + g) | TYPE | TSE | TSD |
+----------------------------+--------+--------+-------------+

Bits “c” are the company-specific bits of the OUI, “u” is the universal/local bit, “g” is the individual/group bit and ‘m’ are the extension identifier bits. In an embodiment, the “u” bit is inverted from its normal sense in the IEEE context; therefore u=l indicates global scope and u=0 indicates local scope.

The OUI field uses the format of IANA's OUI: 00-00-5E with ‘u’ and ‘g’ bits and three octets in length. The Type field specifies interpretation of type-specific extension field (TSE) and type-specific data (TSD). The type field is one octet in length. The type-specific extension field (TSE) is one octet in length. The type-specific data field is three octets in length.

The following interpretations are specified based on the value of the TYPE field:

| TYPE | (TSE, TSD) Interpretation |
|---|---|
| 0x00-0xFD | reserved for future IANA use |
| 0xFE | (TSE, TSD) together contain an embedded IPv4 address |
| 0xFF | TSD is interpreted based on TSE as follows: |

| TSE | TSD Interpretation |
|---|---|
| 0x00-0xFD | reserved for future IANA use |
| 0xFE | TSD contains 24-bit EUI-48 intf identifier |
| 0xFF | reserved by IEEE/RAC |

The present invention provides a new TYPE that indicates that destination address 46 carries an embedded MT-ID as shown below:

|0 2|2 3|3 4|4 6|
|0 3|4 1|2 7|8 3|
+----------------------------+--------+-----------+---------+
|OUI(“00-00-5E” + u + g) | TYPE | MT-ID | TSD |
+----------------------------+--------+-----------+---------+

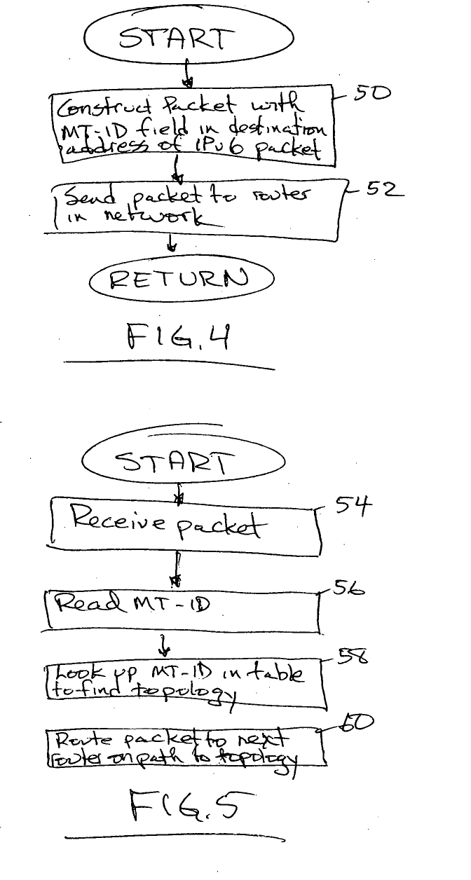

Type-specific data (TSD) is a random value generated in order to have a unique Interface-ID within the link. Directing attention to FIGS. 4 and 5, by using the new TYPE defined above with the MT-ID, the originator of packet 30 can set the MT-ID in packet 30 at act 50, send packet 30 to router 12, and all subsequent routers in the communication path receive packet 30 (act 54) read this MT-ID (act 56) and automatically associate packet 30 with a logical topology by performing a look up of a table in logical topology list 28 in act 58. Once the topology is identified, router 12 also knows which routers lie in the path to the identified topology, and sends packet 30 to the closest router in the path to the identified topology.

While the preferred embodiment of the present invention has been described and illustrated in detail, numerous modifications can be made to embodiments of the present invention without departing from the spirit thereof.

What is claimed is:

1. A method of routing an IPv6 packet in a multi-topology routing network, comprising:
receiving an IPv6 packet;
reading a multi-topology identifier contained in the IPv6 packet, the multi-topology identifier indicating a logical topology of devices within a network having a plurality of logical topologies;
inspecting a local table to find a logical topology of devices in a network, the logical topology associated with the multi-topology identifier contained in the IPv6 packet; and
sending the received IPv6 packet to the logical topology of devices.

2. The method of claim 1, wherein the logical topology comprises a subgroup of routers in a network of routers.

3. The method of claim 1, wherein the IPv6 packet is marked to indicate that it is handled by multi-topology aware routers.

4. The method of claim 1, wherein the IPv6 packet contains a destination address, the destination address having a type that indicates that the destination address includes a multi-topology identifier.

5. The method of claim 1, wherein inspecting a local table to find a logical topology of devices comprises identifying a communication path across a plurality of routers that reaches the logical topology of devices.

6. A method of routing an IPv6 packet in a multi-topology routing network, comprising:
inserting a multi-topology identifier in a destination address portion of an IPv6 packet, the multi-topology identifier identifying one of a plurality of logical topologies of devices in a network; and
sending the IPv6 packet to a router within the network.

7. The method of claim 6, wherein the presence of the multi-topology identifier is indicated by a type definition, the type definition comprising an interface identifier using an IANA OUI assignment.

8. The method of claim 7, wherein the IANA OUI assignment comprises a type field the type field indicating that a field next to the type field contains a multi-topology identifier.

9. A computer-readable medium containing instructions which, when executed by a computer, route an IPv6 packet in a multi-topology routing network, by:
receiving an IPv6 packet;
reading a multi-topology identifier contained in the IPv6 packet, the multi-topology identifier indicating a logical topology of devices within a network having a plurality of logical topologies;
inspecting a local table to find a logical topology of devices in a network, the logical topology associated with the multi-topology identifier contained in the IPv6 packet; and
sending the received IPv6 packet to the logical topology of devices.

10. A computer-readable medium containing instructions which, when executed by a computer, route an IPv6 packet in a multi-topology routing network, by:
inserting a multi-topology identifier in a destination address portion of an IPv6 packet, the multi-topology identifier identifying one of a plurality of logical topologies of devices in a network; and
sending the IPv6 packet to a router within the network.

11. A router, comprising:
means for receiving an IPv6 packet;
means for reading a multi-topology identifier contained in the IPv6 packet, the multi-topology identifier indicating a logical topology of devices within a network having a plurality of logical topologies;
means for inspecting a local table to find a logical topology of devices in a network, the logical topology associated with the multi-topology identifier contained in the IPv6 packet; and
means for sending the received IPv6 packet to the logical topology of devices.

12. A router, comprising:
means for inserting a multi-topology identifier in a destination address portion of an IPv6 packet, the multi-topology identifier identifying one of a plurality of logical topologies of devices in a network; and
means for sending the IPv6 packet to a router within the network.
